(19) United States
(12) Patent Application Publication
(10) Pub. No.: US 2009/0121959 A1
(43) Pub. Date: May 14, 2009

(54) Impedance Matching Circuit and antenna Assembly using the same

(76) Inventors: Kuen-Hua Li, Taishan Township (TW); Wei-Hsiang Wang, Yuanshan Township (TW); Chang-Fa Yang, Taipei City (TW)

Correspondence Address: HDLS Patent & Trademark Services, P.O. BOX 220746, CHANTILLY, VA, 20153-0746, US

(21) Appl. No.: 11/937,542

(22) Filed: Nov. 9, 2007

(51) Int. Cl. H01Q 1/50

(52) U.S. Cl. 343/860

(57) ABSTRACT

An impedance matching circuit converts between an input impedance of an antenna and a characteristic impedance of a transmission line, such as a coaxial cable. The impedance matching circuit includes a transformer and a lumped circuit. The transformer has a primary side and a secondary side. The secondary side is configured to electrically connect with the antenna. The lumped circuit is electrically connected with the primary side, for converting the input impedance of the primary side to the characteristic impedance. An antenna assembly using the above-mentioned impedance matching circuit is also provided.

### BACKGROUND

1. Technical Field

The present invention generally relates to antenna technology and, particularly, to an impedance matching circuit for antennas and an antenna assembly using the impedance matching circuit.

2. Description of the Related Art

In the field of identification and recognition systems and, for example, in the field of radio frequency identification (RFID) systems, a solution must be provided to allow the communication between a reader and an item, such as a tagged item. The identification is typically accomplished by generating a field, such as magnetic field, capable of interacting with and communicating with an identification element, such as a tag, positioned on the item. The magnetic field can either activate or power the tag, in a passive system, or the tag may include internal power sources to facilitate communications with the RFID reader. The magnetic field is typically generated by way of applying energy in the manner of current to a reader antenna. A loop-type antenna is frequently used as the reader antenna. The loop-type antenna is powered and emits the magnetic field, which is used in identifying objects or items within the field. The energy applied to the reader antenna is generally supplied from the RFID reader through a transmission line, such as a coaxial cable. In this situation, the RFID reader acts as an RF source.

In practice, the coaxial cable generally has a characteristic input impedance (hereinafter also referred to as “characteristic impedance”), e.g., 50 ohms. In order to achieve a high efficient energy transfer from the RFID reader to the loop-type antenna, the loop-type antenna ought to have an input impedance substantially equal to that of the coaxial cable. However, the loop-type antenna generally has an input impedance different from that of the coaxial cable, and therefore, what is needed is an impedance matching circuit to convert the input impedance of the loop-type antenna to match to the characteristic impedance.

### BRIEF SUMMARY

The present invention is an impedance matching circuit for converting between an input impedance of an antenna and a characteristic impedance of a transmission line.

Furthermore, the present invention is an antenna assembly having an impedance matching circuit for converting between an input impedance of an antenna and a characteristic impedance.

The antenna assembly comprises an antenna and the above-mentioned impedance matching circuit. The impedance matching circuit comprises a transformer and a lumped circuit. The transformer comprises a primary side and a secondary side. The secondary side is electrically connected with the antenna. A resistance of the primary side is a multiple of a resistance of the secondary side. The lumped circuit, typically an inductor-capacitor circuit, is electrically connected with the primary side to convert the input impedance of the primary side to the characteristic impedance.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a schematic circuit connection diagram of an impedance matching circuit, in accordance with a present embodiment.

FIG. 2 is a schematic view of an antenna assembly using the impedance matching circuit of FIG. 1, showing a loop-type antenna of which a main body has one pair of coupled sections.

FIG. 3 is a schematic view of another antenna assembly using the impedance matching circuit of FIG. 1, showing that a loop-type antenna of which a main body has two pairs of coupled sections.

### DETAILED DESCRIPTION

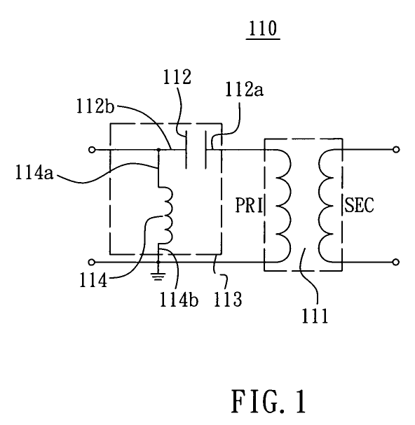

Referring to FIG. 1, an impedance matching circuit 110 applicable to RFID, in accordance with a present embodiment, is provided. The impedance matching circuit 110 is for converting between an input impedance of an antenna and a characteristic impedance. In particular, the impedance matching circuit 110 converts the input impedance of the antenna and an input impedance of a coaxial cable so that energy (e.g., RF signal) from an RFID reader may be transmitted to the antenna. The impedance matching circuit 110 comprises a transformer and a lumped circuit, typically an inductor-capacitor circuit 113. The transformer 111 comprises a primary side PRI and a secondary side SEC. It is indicated that the terms “primary side” and “secondary side” are interchangeable, which depends on one's perspective. The secondary side SEC is configured to electrically connect with the antenna (not shown). The inductor-capacitor circuit 113 is electrically connected with the primary side PRI to convert the input impedance of the primary side PRI to the characteristic impedance. A resistance of the primary side PRI is a multiple of a resistance of the secondary side SEC. More specifically, a ratio of the number of turns Np in the primary side PRI to the number of turns Ns in the secondary side SEC is designed based on the difference between the impedance of the antenna and the characteristic impedance. The multiple Rp/Rs between the resistance of primary side PRI and the resistance of the secondary side SEC generally satisfies the equation: Rp/Rs=(Np/NS)², wherein the Rp and Rs respectively are the resistances of the primary side PRI and the secondary side SEC of the transformer 111.

For the purpose of illustration, the inductor-capacitor circuit 113 of FIG. 1 comprises one capacitor 112 and one inductor 114. The capacitor 112 has a first terminal 112a and a second terminal 112b. The inductor 114 has a first terminal 114a and a second terminal 114b. The first terminal 112a of the capacitor 112 is electrically connected with one terminal of the primary side PRI. The second terminal 112b thereof is electrically connected with the first terminal 114a of the inductor 114. The second terminal 114b of the inductor 114 is electrically connected with ground and the other terminal of the primary side PRI. An input impedance between the first terminal 114a of the inductor 114 and ground is equal to or close to the characteristic impedance. The number and the connections of inductors and capacitors in the inductor-capacitor circuit 113 are designed based on the difference between the input impedance of the primary side PRI and the characteristic impedance. Those skilled in the art can determine the number and the connections with reference to a Smith chart.

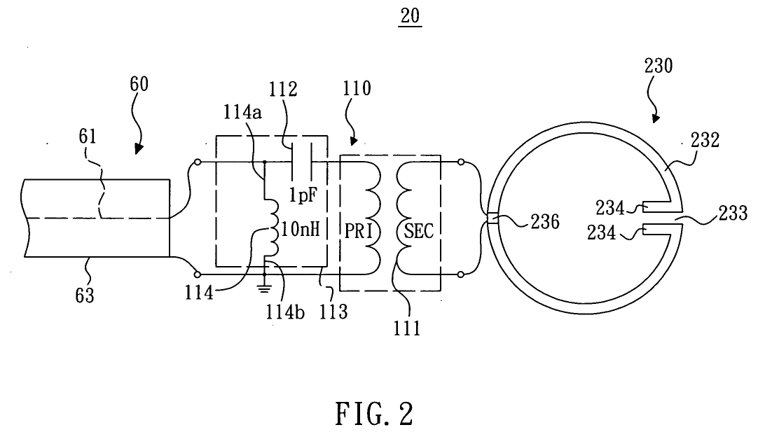

Referring to FIG. 2, an antenna assembly 20 in accordance with another present embodiment is provided. The antenna assembly 20, specifically applied to RFID, comprises a loop-type antenna 230 and the impedance matching circuit 110.

The loop-type antenna 230 comprises an electrically conductive main body and a feed portion 236. The main body comprises an electrically conductive single turn loop member 232 and one pair of coupled sections 234. The single turn loop member 232 has one gap 233. Each section of the pair 234 is connected with one end of the gap 233. The sections of the pair 234 have identical extension direction facing an internal area of the single turn loop member 232. A length of the main body is preferably close to but no more than λ/2, wherein the λ is an operating wavelength of the radio frequency identification. The operating wavelength λ satisfies the equation that λ=c/f, wherein c is approximately equal to 3×10⁸ meters per second (m/s) and f is an operating frequency of the radio frequency identification. For example, when the operating frequency f is in the 900 MHz frequency range, particularly at 915 MHz, the length of the main body rather suitably is close to but no more than about 16 centimeters correspondingly.

The feed portion 236 is electrically connected with the single turn loop member 232 of the main body in the manner that the single turn loop member 232 is substantially symmetrical in terms of the feed portion 236. The feed portion 236 also is electrically connected to the secondary side of the transformer 111.

The first terminal 114a and the second terminal 114b of the inductor 114 are electrically connected to a coaxial cable 60 which is connected with an RFID reader (not shown). The coaxial cable 60 generally comprises a single inner conductor 61 and an outer conductor 63. The single inner conductor 61 and the outer conductor 63 are respectively connected with the first terminal 114a and the second terminal 114b of the inductor 114.

For the purpose of illustration, assuming that the input impedance of the loop-type antenna 230 at 915 MHz is about (4.74-j6.07) ohms. In order to convert the input impedance of the loop-type antenna 230 to a typical characteristic impedance of about 50 ohms, the ratio of (Nₚ/Nₛ)², i.e., the multiple can be set to be 4. Therefore, a measured impedance of the primary side PRI of the transformer 111 is about (20+j87) ohms. The purpose of the transformer 111 is to convert the input impedance of the loop-type antenna 230 largely. Then, the inductance of the inductor 114 and the capacitance of the capacitor 112 are determined by a Smith chart so that the input impedance of the primary side PRI is equal to or close to the typical characteristic impedance of about 50 ohms. In particular, the inductance of the inductor 114 and the capacitance of the capacitor 112 are respectively 10 nH and 1 pF. It is noted that due to the isolation of the transformer 111 for unbalanced induced currents (common-mode currents), the transformer 111 also acts as a Balun of the loop-type antenna 230 and thus can effectively suppress the unbalanced induced current in the outer conductor 63 of the coaxial cable 60.

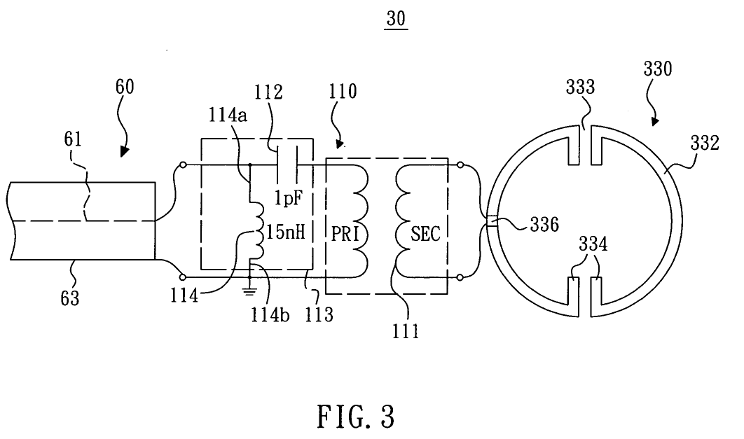

Referring to FIG. 3, an antenna assembly 30 for radio frequency identification, in accordance with still another present embodiment, is provided. The antenna assembly 30 comprises a loop-type antenna 330 and the impedance matching circuit 110.

The loop-type antenna 330 comprises an electrically conductive main body and a feed portion 336. The main body comprises an electrically conductive single turn loop member 332 and two pairs of coupled sections 334. The single turn loop member 332 has two gaps 333. Each section of one of the pairs 334 is connected with one end of the corresponding one of the gaps 333. The two gaps 333 are disposed at two ends of a diameter of the single turn loop member 332. The pairs 334 have an identical extension direction facing an internal area of the single turn loop member 332. A length of the main body is preferably close to but no more than λ/2, wherein the λ is an operating wavelength of the radio frequency identification. The feed portion 336 is electrically connected with the single turn loop member 332 of the main body in the manner that the single turn loop member 332 is substantially symmetrical in terms of the feed portion 336. The feed portion 336 also is electrically connected to the secondary side SEC of the transformer 111.

The input impedance of the loop-type antenna 330 at 915 MHz is about (9.4+j10) ohms. The impedance matching circuit 110 shown in FIG. 3 can be used to match the typical characteristic impedance of about 50 ohms.

It is understood that the antennas of the antenna assemblies 20, 30 are not limited to a loop-type antennas.

The above description is given by way of examples, and not limitation. Given the above disclosure, one skilled in the art could devise variations that are within the scope and spirit of the invention disclosed herein, including configuration ways of the recessed portions and materials and/or designs of the attaching structures. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. An impedance matching circuit for converting between an input impedance of an antenna and a characteristic impedance of a transmission line, the impedance matching circuit comprising:
a transformer comprising a primary side and a secondary side, the secondary side being configured to electrically connected with the antenna, a resistance of the primary side being a multiple of a resistance of the secondary side; and
a lumped circuit, connected with the primary side, for converting an input impedance of the primary side to the characteristic impedance.

2. The impedance matching circuit according to claim 1, wherein the multiple is 4.

3. The impedance matching circuit according to claim 1, wherein the lumped circuit includes an inductor and a capacitor, the inductor has a first terminal and a second terminal, the capacitor has a first terminal and a second terminal, the first terminal of the capacitor is connected with the primary side, the second terminal of the capacitor is connected with the first terminal of the inductor, the second terminal of the inductor is connected with ground, and an input impedance between the first terminal of the inductor and ground matches the characteristic impedance.

4. The impedance matching circuit according to claim 3, wherein the inductor is 10 nH and the capacitor is 1 pF when the input impedance of the antenna is about 4.74−j6.07Ω at 915 MHz.

5. The impedance matching circuit according to claim 3, wherein the inductor is 15 nH and the capacitor is 1 pF when the input impedance of the antenna is about 9.4+j10Ω at 915 MHz.

6. An antenna assembly, comprising:
an antenna; and
an impedance matching circuit, comprising:
a transformer comprising a primary side and a secondary side, the secondary side being electrically connected with the antenna, a resistance of the primary side being a multiple of a resistance of the secondary side; and
a lumped circuit, electrically connected with the primary side, for converting an input impedance of the primary side to a characteristic impedance of a transmission line.

7. The antenna assembly according to claim 6, wherein an input impedance of the antenna is about 4.74−j6.07Ω at 915 MHz.

8. The antenna assembly according to claim 6, wherein an input impedance of the antenna is about 9.4+j10Ω at 915 MHz.

9. The antenna assembly according to claim 6, wherein the multiple is 4.

10. The antenna assembly according to claim 6, wherein the input impedance of the primary side is about 20+j87Ω at 915 MHz.

11. The antenna assembly according to claim 6, wherein the lumped circuit includes an inductor and a capacitor, the inductor has a first terminal and a second terminal, the capacitor has a first terminal and a second terminal, the first terminal of the capacitor is connected with the primary side, the second terminal of the capacitor is connected with the first terminal of the inductor, the second terminal of the inductor is connected with ground, and an input impedance between the first terminal of the inductor and ground matches the characteristic impedance.

12. The antenna assembly according to claim 11, wherein the inductor is 10 nH and the capacitor is 1 pF when an input impedance of the antenna is about 4.74-j6.07Ω at 915 MHz.

13. The antenna assembly according to claim 11, wherein the inductor is 15 nH and the capacitor is 1 pF when an input impedance of the antenna is about 9.4+j10Ω at 915 MHz.
